(19) United States
(12) Patent Application Publication
(10) Pub. No.: US 2009/0306853 A1
(43) Pub. Date: Dec. 10, 2009

(54) Method and device for the detection of a low-friction cefficient roadway

(76) Inventor: Gerald Graf, Remseck (DE)

Correspondence Address: KENYON & KENYON LLP, ONE BROADWAY, NEW YORK, NY, 10004, US

(21) Appl. No.: 11/921,627

(22) PCT Filed: Apr. 26, 2006
(86) PCT No.: PCT/EP2006/061848

§ 371 Date: May 26, 2009

(30) Foreign Application Priority Data
Jun. 15, 2005 (DE) 102005027647.4

(51) Int. Cl. B62D 6/00; G06F 17/00

(52) U.S. Cl. 701/40; 701/1

(57) ABSTRACT

A method for detecting the presence of a low-coefficient of friction roadway, in which a group is specified that includes one or more predetermined types of driving situation, the at least twofold occurrence of a type of driving situation included in the group is ascertained, the same type of driving situation not necessarily having to be involved, and the presence of a low-coefficient of friction roadway is detected as a function of this.

### BACKGROUND INFORMATION

Conventional warnings to the driver of a slippery roadway via the instrument cluster are based on the measured outside temperature. If this falls below a specified value, such as 4° C., then a warning notice of a slippery road will appear, for instance, on a display of the instrument cluster. The actual condition of the roadway is not considered in this connection, and the warning is also generated if there is no slippery road and only low temperatures are prevailing.

### SUMMARY

The present invention relates to a method for detecting the presence of a low-friction coefficient roadway or roadway having a low coefficient of friction, in which
a group is specified that includes one or more specified types of driving situation,
the at least twofold occurrence of a type of driving situation included in the group is ascertained, the same type of driving situation not necessarily having to be involved, and
the presence of a low-coefficient of friction roadway is detected as a function of this.

This may make it possible to achieve a more precise and sure-fire detection of a low-coefficient of friction roadway than by using an outside thermometer.

In an advantageous refinement of the present invention, the group includes at least two different types of driving situation. By considering a broader range of driving situations, the reliability of the detection is further improved.

One advantageous refinement of the present invention is characterized in that for each type of predetermined driving situation that has occurred, a slipperiness variable is ascertained which represents the probability that a low-coefficient of friction roadway is present, and/or a high-coefficient of friction variable is ascertained which represents the probability that a roadway having a high coefficient of friction is present, and as a function of the ascertained slipperiness variables and/or the ascertained high-coefficient of friction variable the presence of a low-coefficient of friction roadway is detected. That makes it possible for different driving situations, upon their occurrence, to enter into the ascertainment of the presence of a low-coefficient of friction roadway, using different weightings.

One advantageous refinement of the present invention is characterized in that for each predetermined type of driving situation that has occurred, a weighting is ascertained which is a function of how long the predetermined type of driving situation that has occurred has been present.

This takes into consideration that long lasting driving situations permit drawing more precise conclusions as to the presence of a low-coefficient of friction roadway than only briefly present driving situations.

An advantageous refinement of the present invention is characterized in that, according to the relationship

$$F\_low \_mue = \frac{{\sum }_{i} f\_low \_mue \_event \_i \cdot Gew\_i}{\begin{matrix}{\sum }_{i} f\_low \_mue \_event \_i \cdot Gew\_i + \\ {\sum }_{i} f\_high \_mue \_event \_i \cdot Gew\_i\end{matrix}}$$

a variable f_low_mue is ascertained which is a measure of the probability that a low-coefficient of friction roadway is present, and that a low-coefficient of friction roadway is detected as being present if the variable f_low_mue exceeds a specified boundary value,
where, for the given relationship,
i is a continuous counter for the number of predetermined driving situations that have occurred,
f_low mue_event_i and f_high_mue_event_i are the ascertained slipperiness variable and high-coefficient of friction variable for the ith predetermined type of driving situation that has occurred,
Gew_i is the weighting for the ith predetermined type of driving situation that has occurred.

One advantageous refinement of the present invention is characterized in that at least one predetermined type of driving situation depends on whether a wheel slip control system is active.

One advantageous refinement of the present invention is characterized in that at least one predetermined type of driving situation depends on the intensity of the brake pedal actuation of a braking carried out by the driver.

One advantageous refinement of the present invention is characterized in that at least one predetermined type of driving situation is a function of the present vehicle acceleration.

One advantageous refinement of the present invention is characterized in that at least one predetermined type of driving situation is a functions of the difference between the vehicle's deceleration and at least one wheel deceleration during a braking procedure.

One advantageous refinement of the present invention is characterized in that at least one predetermined type of driving situation is a function of the change in the wheel deceleration per unit of time.

The variables named, such as the status of wheel slip control systems, the intensity of a brake pedal actuation, a vehicle acceleration, a wheel deceleration, a vehicle deceleration and the change in the wheel deceleration per unit of time are able to be ascertained using sensors that are present in modern vehicles without any substantial additional expenditure, and thus they permit a low-cost detection of specified types of driving situation.

One advantageous refinement of the present invention is characterized in that a warning to the driver takes place, in case of the detection of a low-coefficient of friction roadway. This suggests to the driver that he adapt his driving manner to the conditions on the roadway.

The example device, according to the present invention, for detecting the presence of a low-coefficient of friction roadway includes
a storage device, in which a group including one or more predetermined types of driving situation are stored,
an ascertainment device, in which the at least twofold occurrence of a type of driving situation included in the stored group is ascertained, the same type of driving situation not necessarily having to be involved, and
a detection device, by which the presence of a low-coefficient of friction roadway is detected, as a function of the at least twofold occurrence ascertained in the means of ascertainment of a type of driving situation included in the stored group.

The advantageous refinements of the method according to the present invention manifest themselves also as advantageous refinements of the device according to the present invention, and vice versa.

### BRIEF DESCRIPTION OF THE DRAWINGS

FIG. 1 shows the basic sequence of an example method according to the present invention.

FIG. 2 shows the basic configuration of an example apparatus according to the present invention.

FIG. 3 shows a specific example embodiment of the present invention.

### DETAILED DESCRIPTION OF EXAMPLE EMBODIMENTS

The present invention makes it possible to gather data on the prevailing condition of the roadway, via the usual brake control functions ABS, ASR and ESP (ESP=“electronic stability program”) and via the normally used sensor system (transverse acceleration, yaw rate, steering wheel angle, wheel speeds), and to display a warning to the driver on the instrument cluster only upon detection of slipperiness of the road.

The present invention is based on the fact that, in the case of a roadway that is slippery with snow, ABS/ASR/ESP interventions occur at clearly lower accelerations or decelerations than would be the case on a dry roadway. An additional indication of roadway slipperiness may be gathered from wheel signals in conjunction with light braking, even without an ABS regulation taking place. Furthermore, high accelerations that occur are an indication of a dry and grip-providing roadway. It is an advantage of the present invention if a warning to the driver is only given out if slipperiness of the roadway actually prevails. What is avoided is the driver becoming accustomed to a permanently displayed warning, as is the case in the temperature-triggered approach. In the case of vehicles having a conventional ESP system or ABS system, the driver experiences a feedback by the pulsing in the brake pedal when there is to be an ABS regulation, However, this feedback is omitted in vehicles having EHB systems (EHB=electrohydraulic brake). A warning to the driver according to the present invention is able to replace this missing feedback.

The example algorithm for estimating the condition of the roadway is based on an evaluation of various driving conditions which are typical for roadways slippery with snow and for dry asphalt.

Typical driving conditions for roadways slippery with snow:

Driving Condition A1:

There is a slight vehicle acceleration and an ASR regulation or an ESP regulation is active.

Vehicle Condition A2:

There is a weak braking procedure and an ABS regulation is active.

Driving Condition A3:
there is a weak braking procedure,
there is a large difference between at least one wheel deceleration and the ascertained vehicle deceleration, and
there is an irregular wheel behavior, recognizable by large values for the derivative with respect to time of the wheel deceleration, i.e., the jerking sequence of the wheels.

Typical driving conditions for dry asphalt:

Driving Condition B1:
there is a weak braking procedure,
there is a slight difference between at least the wheel decelerations and the ascertained vehicle deceleration, and
there is a steady wheel behavior, recognizable by small values for the derivative with respect to time of the wheel deceleration.

Driving condition B2:

there is at least a medium strong braking procedure and no ABS regulation is active

Driving condition B3:

there is an at least medium strong vehicle acceleration without an ASR regulation or an ESP regulation being active

Driving condition B4:

there is a great vehicle acceleration

In the case of the vehicle acceleration evaluated in response to conditions A1, B3 and B4, in particular the entire vehicle acceleration is involved, which is able to have longitudinal acceleration components and transverse acceleration components. It is evaluated according to

a=SQRT(ax²+ay²),

where SQRT denotes the square root function, ax denotes, the vehicle's longitudinal acceleration ascertained, for instance, from wheel rotary speed sensor signals, and ay is the transverse acceleration measured, for instance, using the transverse acceleration sensors.

The intensity of the braking procedure in conditions A2, A3, B1 and B2 is detected, for instance, with the aid of the admission pressure detected by an admission pressure sensor and/or the vehicle's longitudinal acceleration, or deceleration, ascertained, for instance, from the wheel rotary speeds.

To each of these conditions, individual estimated probabilities f_low_mue_event and/or f_high_mue_event are assigned, as well as a weighting factor Gew.

If one of conditions A1, A2, A3, B1, . . . , B4 is present, a variable f_low_mue_event is calculated from the individual signals (for example, the combination of 4 wheel signals to one variable) pertaining to the respective situation, via, e.g., a fuzzy-logic method, which gives the probability as to whether there is a slippery roadway in response to the present condition. In an analogous manner, variable f_high_mue_event gives the probability as to whether, in the case of the instantaneously present condition, a grip-providing, asphalt-paved roadway is involved. At any given condition, it is not absolutely required that one of the probabilities assumes the value 1 and the other probability assumes the value 0. It is also possible that, at a given condition f_low_mue_event and f_high_mue_event both assume a value different from zero, with f_low_mue_event+f_high_mue_event=1.

Into the ascertainment of weighting factor Gew, there enters, for instance, how long the conditions for a roadway slippery with snow, or an asphalt roadway, have been satisfied, that is, how suitable the situation is for evaluation.

The presence of the above-named driving conditions A1, A2, A3, B1, . . . , B4 is recognized using the present invention, and the weighting factor assigned to the respectively present driving condition is ascertained. For the ascertainment of the weighting factor, the present driving conditions are evaluated as long as the driving conditions persist. Subsequently, a variable f_low_mue can be determined, via a fuzzy-logic method, which is a measure for whether the evaluated driving conditions rather point to a slippery roadway or rather to a grip-providing roadway. The presence of a slippery roadway is signaled to the driver if the quantity f_low_mue exceeds a specified boundary value, such as 0.8.

For this, the quantity f_low_mue is ascertained, for instance, using the following relationship:

$$F\_low \_mue = \frac{{\sum }_{i} f\_low \_mue \_event \_i \cdot Gew\_i}{\begin{matrix}{\sum }_{i} f\_low \_mue \_event \_i \cdot Gew\_i + \\ {\sum }_{i} f\_high \_mue \_event \_i \cdot Gew\_i\end{matrix}}$$

where
i denotes the condition that has occurred last of the above-named driving conditions A1, A2, A3, B1, . . . , B4,
f_low_mue_event_i and f_high_mue_event_i characterize the probabilities of a slippery roadway or dry asphalt and of driving condition i that has occurred last and
Gew_i denotes the weighting factor for driving condition i that has occurred last.

A warning notice, for example, can be output to the driver as a function of variable f_low_mue or a wheel slip control system, or a driving dynamics controller can be influenced.

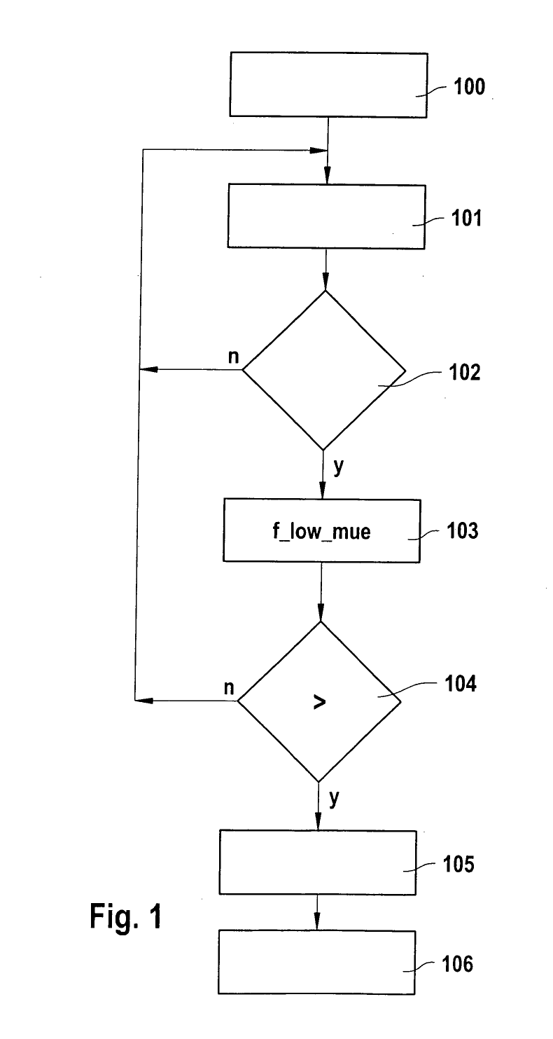

Execution of the method according to the present invention is depicted in FIG. 1. After the start in block 100, the present type of driving situation is recorded in block 101. Subsequently, it is queried in block 102 whether an at least twofold occurrence of a type of driving situation included in the group is present, it not being absolutely necessary that the same type of driving situation is involved. If the answer is “no” (always indicated by “n” in FIG. 1), then the system branches back to block 101. On the other hand, if the response is “yes” (always indicated in FIG. 1 by “y”), then variable f_low_mue is subsequently ascertained in block 103. In block 104 it is then queried whether variable f_low_mue exceeds a specified boundary value. If this is not the case, the system branches back to the input of block 101, and there the next occurring predetermined type of driving situation is recorded. However, if the query in block 104 is fulfilled, the presence of a roadway having a low coefficient of friction is established in block 105, and, for instance, the driver is notified. Thereafter, the method ends in block 106, or further corresponding situations are evaluated, in order thereby to take into consideration a possible change in the roadway condition and to correct erroneous estimates. Furthermore, it is possible to prevent oscillation in the warning notice by using hysteresis, that is, in the case of f_low_mue>0.6, the low-coefficient of friction warning is set, and in the case of f_low_mue<0.4, the low-coefficient of friction warning is rescinded again. The numerical values 0.4 and 0.6 are only exemplary values.

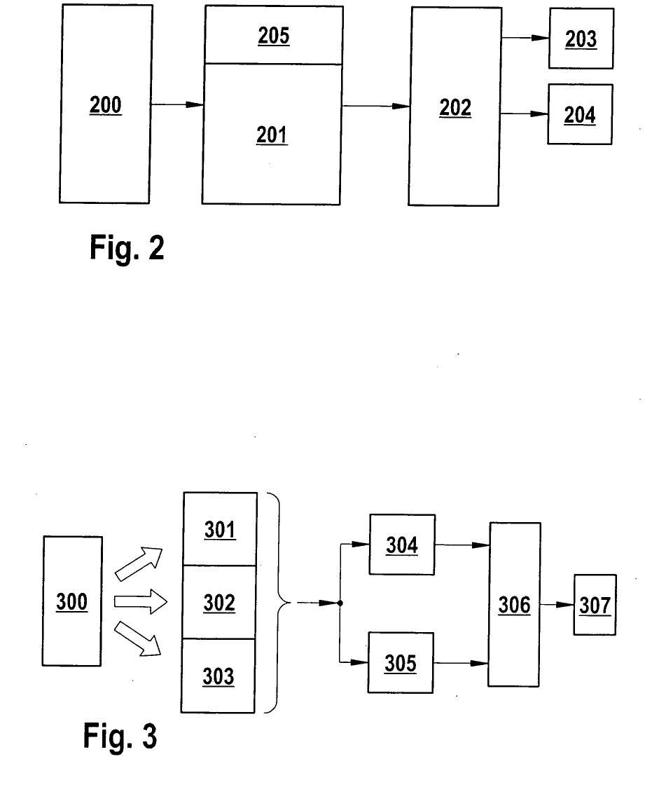

The design of the example device, according to the present invention, for detecting the presence of a low-coefficient of friction roadway is shown in FIG. 2. In this context, block 205 a storage device in which a group, including one or more predetermined types of driving situation, is stored. Block 201 includes an ascertainment device, in which the at least twofold occurrence of a type of driving situation included in the stored group is ascertained, the same type of driving situation not necessarily having to be involved. For this, block 201 receives input signals from a sensor 200, block 200 includes, for instance, wheel rotary speed sensors and an admission sensor for ascertaining the driver's braking command. The current driving situation is ascertained using these sensor signals in block 201, and comparing them to the types of driving situation stored in block 205. Moreover, FIG. 2 includes detection device 202, by which the presence of a low-coefficient of friction roadway is detected, as a function of the at least twofold occurrence ascertained in the ascertainment device 201 of a type of driving situation included in the stored group. If there is a low-coefficient of friction roadway present, then, for instance, either a driver notice can be output via a driver warning device 203 and/or wheel slip control means 204 can be influenced.

FIG. 3 again shows once again a specific embodiment of an example embodiment according to the present invention in an alternative representation. In blocks 301, 302 and 303, the instantaneous driving condition is recorded, using the output signals of the sensors included in block 300. The following can be detected, for example:
in block 301, the presence of a partial braking, that is, a weak braking,
in block 302, the instantaneous activity of an ABS regulation, an ASR regulation or an ESP regulation, and
in block 303, the presence of a large vehicle acceleration.

As a function of the driving condition recorded in block 301 and/or 302 and/or 303, it is classified, if indicated, in block 304, as indicating a low-coefficient of friction roadway, or in block 305 as indicating a high-coefficient of friction roadway. To do this, a method based on fuzzy logic can, in particular, also be used. This permits the calculation of probabilities for the present driving condition, that is, a low-coefficient of friction roadway is present having a probability x, and a high-coefficient of friction roadway is present having a probability 1−x. Thereafter, in block306, for example, the quotient

the number of low-coefficient of friction driving conditions/(the number of low-coefficient of friction driving conditions +the number of high-coefficient of friction driving conditions)

or a related variable such as f_low_mue is formed. The presence of a low-coefficient of friction roadway is detected based on this quotient.

1-12. (canceled)

13. A method for detecting the presence of a low-coefficient of friction roadway, comprising:
specifying a group that includes at least one predetermined type of driving situation;
ascertaining at least a twofold occurrence of a type of driving situation included in the group, the same type of driving situation not necessarily having to be involved; and
detecting a presence of a low-coefficient of friction roadway as a function of the ascertaining.

14. The method as recited in claim 13, wherein the group includes at least two different types of driving situations.

15. The method as recited in claim 13, wherein, for each type of predetermined driving situation that has occurred, at least one of: i) a slipperiness variable is ascertained which represents a probability that a low-coefficient of friction roadway is present, and ii) a high-coefficient of friction variable is ascertained which represents a probability that a roadway having a high coefficient of friction is present; and wherein as a function of the at least one of the ascertained slipperiness variables and the ascertained high-coefficient of friction variables, a presence of a low-coefficient of friction roadway is detected.

16. The method as recited in claim 15, wherein for each predetermined type of driving situation that has occurred, a weighting factor is ascertained, which is a function of how long the predetermined type of driving situation that has occurred is present.

17. The method as recited in claim 16, wherein, according to a relationship
$$f\_low \_mue = \frac{{\sum }_{i} f\_low \_mue \_event \_i \cdot Gew\_i}{\begin{matrix}{\sum }_{i} f\_low \_mue \_event \_i \cdot Gew\_i + \\ {\sum }_{i} f\_high \_mue \_event \_i \cdot Gew\_i\end{matrix}}$$
a variable f_low_mue is ascertained, which is a measure for a probability that a low-coefficient of friction roadway is present, and that a low-coefficient of friction roadway is detected as being present if the variable f_low_mue exceeds a specified boundary value, where, for the relationship,
i is a counter for the predetermined types of driving situation that have occurred,
f_low_mue_event_i and f_high_mue_event_i are the ascertained slipperiness variable and high-coefficient of friction variable for the ith predetermined type of driving situation that has occurred,
Gew_i is the weighting factor for the ith predetermined type of driving situation that has occurred.

18. The method as recited in claim 12, wherein at least one of the predetermined types of driving situations depends on whether a wheel slip control system is active.

19. The method as recited in claim 12, wherein at least one of the predetermined types of driving situations is a function of an intensity of an actuation of a brake pedal in a braking process carried out by a driver.

20. The method as recited in claim 12, wherein at least one of the predetermined types of driving situations is a function of a present vehicle acceleration.

21. The method as recited in claim 12, wherein at least one of the predetermined types of driving situations is a function of a difference between a deceleration of a vehicle and at least one wheel deceleration during a braking procedure.

22. The method as recited in claim 12, wherein at least one of the predetermined types of driving situations is a function of a change in a wheel deceleration per unit of time.

23. The method as recited in claim 12, wherein a driver warning takes place in case of a detection of a low-coefficient of friction roadway.

24. A device for detecting a presence of a low-coefficient of friction roadway, comprising:
a storage device, in which a group including at least one predetermined type of driving situation is stored;
an ascertainment device, in which an at least twofold occurrence of a type of driving situation included in the stored group is ascertained, the same type of driving situation not necessarily having to be involved; and
a detection device, by which a presence of a low-coefficient of friction roadway is detected, as a function of the at least twofold occurrence ascertained in the ascertainment device of a type of driving situation included in the stored group.
